(19) United States
(12) Patent Application Publication
(10) Pub. No.: US 2022/0317787 A1
(43) Pub. Date: Oct. 6, 2022

(54) ELECTRONIC INPUT DEVICES WITH TRANSFORMATIVE TIPS

(71) Applicant: Hewlett-Packard Development Company, L.P., Spring, TX (US)

(72) Inventor: Hsiang-Ta Ke, Taipei City (TW)

(73) Assignee: Hewlett-Packard Development Company, L.P., Spring, TX (US)

(21) Appl. No.: 17/633,636

(22) PCT Filed: Oct. 11, 2019
(86) PCT No.: PCT/US2019/055899

§ 371 Date: Feb. 8, 2022

(51) Int. Cl. G06F 3/0354; G06F 3/038

(52) U.S. Cl. CPC G06F 3/03545; G06F 3/0383

(57) ABSTRACT

In one example in accordance with the present disclosure, an electronic input device housing is described. The housing includes a shaft to house a writing implement. The housing also includes a transformative tip coupled to the shaft to selectively expose the writing implement as it advances through an opening in the transformative tip. An electrically conductive material is formed over the transformative tip. The housing also includes a trigger to advance the writing implement through the opening.

### BACKGROUND

Input devices communicate with electronic devices such as computers, tablets, and other electronic devices. These input devices allow a user to interact with the electronic device. One example of an input device is an electronic pen. The writing end of the electronic pen includes a tip that can be pressed on a surface, such as a touch-screen display. The contact force between the tip and the surface can be used to execute operations within an application, such as clicking on buttons/icons within the application. In some examples, the tip is moved across the surface, and a visual representation of the motion is displayed on the touch-screen display. In this fashion, the electronic pen can be used to write text, draw images, or interface with an application on the electronic device.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic input device housing with a transformative tip, according to an example of the principles described herein.

FIGS. 2A and 2B are views of an electronic input device with a retractable cover, according to an example of the principles described herein.

FIGS. 3A and 3B are zoomed-in views of the tip of the shaft of the electronic input device and the retractable cover, according to an example of the principles described herein.

FIGS. 4A and 4B are views of an electronic input device with a deformable opening, according to another example of the principles described herein.

FIGS. 5A and 5B are zoomed-in views of the tip of the shaft of the electronic input device and the deformable opening, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

An electronic pen is an input device that is held by a user and used to interact with a computing device. For example, a user may grasp the electronic pen, move it across a surface to form text and/or images on the computing device screen. The electronic pen may also be used in other forms of user interaction. For example, the user may select icons on applications executing on the computing device to carry out a particular function. The writing end of the electronic pen includes a tip that can be pressed on a surface, such as a touch-screen display. The input device, or electronic pen can be used with other surfaces as well, such as paper designed to be used with electronic pens. While specific reference is made to a few types of surfaces, any number of surfaces could be implemented in accordance with the principles described herein.

In other words, an electronic pen is an input device which captures the handwriting or brush strokes of a user and converts pen movements into digital data, enabling the movements to be utilized in various applications or rendered directly to a digital display. The surface with which the input device interfaces may be of a variety of types. For example, the surface may be a display screen on an electronic device, which display screen is responsive to touch inputs, such as from a finger or other device such as an electronic pen. In another example, the surface may be a paper surface that is specially-prepared to support electronic inputs. For example, this specially-prepared paper may include features that are imperceptible to the human eye. As the tip passes over these features, it identifies the position of the tip on the specially-prepared paper surface.

The contact force between the tip and the surface can be used to execute operations within an application, such as clicking on buttons/icons within the application. In some examples, the tip is moved across the surface, and a visual representation of the motion is displayed on the touch-screen display, or other surface. In this fashion, the electronic pen can be used to write text, draw images, or interface with an application on the electronic device.

While such electronic pens allow a user to provide input to an electronic device, some characteristics limit their more thorough implementation. For example, a user may simultaneously be using an electronic pen to interact with a computing device and a writing implement such as a pen or a pencil. Switching between a task that uses the writing implement and one that uses the electronic pen is distracting to a user and may result in an interruption to work flow or productivity over an extended period of time.

Accordingly, the present specification describes an electronic pen, or “stylus” that includes a writing implement such as an ink pen or a lead pencil inside the electronic pen. When used to create physical marks, the pen or pencil protrudes through an opening in the tip. When used as an electronic pen, i.e., on an electronic surface or specialized sensing paper, the writing implement is retracted into the interior of the electronic input device and a transformative tip of the stylus encloses the writing implement such that the electronic pen may be effectively used as such. The electronic pen may include a button on top, or other trigger, that when depressed retracts the writing implement and a rubber tip closes for a nib capacitance. Accordingly, the present specification provides for an electronic pen that can be used in two modes, a first as a stylus on touch screens and a second as a pencil/pen on paper.

Specifically, the present specification describes an electronic input device housing. The housing includes a shaft to house the writing implement. A transformative tip is coupled to the shaft and selectively exposes the writing implement as it advances through an opening in the transformative tip. The housing also includes an electrically conductive material formed over the transformative tip. The housing also includes a trigger to advance the writing implement through the opening.

The present specification also describes an electronic input device. The electronic input device includes a housing, which includes a shaft and a transformative tip coupled to the shaft. The transformative tip has an opening through which a writing implement is to advance during use. An electrically conductive material is formed over the tip. The housing also includes at least one trigger to advance the writing implement through the opening. The electronic input device also includes at least one writing implement disposed within the shaft.

The present specification also describes another example of an electronic input device. The electronic input device includes a housing. The housing includes a cylindrical shaft and a transformative tip coupled to the shaft. The transformative tip includes an opening through which a writing implement is to advance during use. An electrically conductive material is formed over the transformative tip and is to interface with a surface. The housing also includes at least one trigger to advance a writing implement through the opening. The input system also includes multiple writing implements.

Such devices and systems 1) facilitate electronic pen use and physical writing implement use in a single device; automatically extract a desired writing implement; and 3) covers any orifice when a writing implement is not in use to prevent contamination. However, it is contemplated that the devices disclosed herein may address other matters and deficiencies in a number of technical areas.

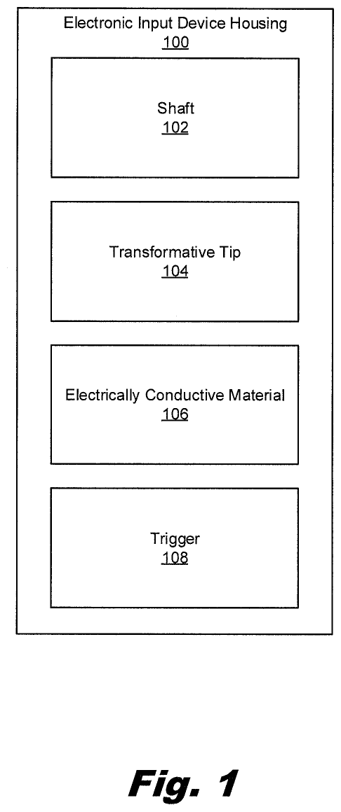

Turning now to the figures, FIG. 1 is a block diagram of an electronic input device housing (100) with a transformative tip (104), according to an example of the principles described herein. The transformative tip (104) of the shaft (102) is formed of, or covered by, an electrically conductive material (106) such as a conductive rubber. During use, the electrically conductive material (106) allows the shaft (102) to be used as a stylus on a touch-sensitive display. To make physical marks on physical media, a trigger (108) may be activated on the shaft (102) to advance the writing implement through the opening in the tip.

Accordingly, the electronic input device housing (100) includes a shaft (102) to house a writing implement. Coupled to the shaft (102) is a transformative tip (104). The transformative tip (104), when in an electronic pen mode, may be used as a scribing shaft that contacts a surface to generate an output. For example, a user may press the tip (104) of the electronic input device housing (100) against a surface such as a digital display and/or a touch screen display. Doing so causes the tip (104) to translate such that digital operations can be executed and/or digital marks such as text and images may be generated on the digital display or touch screen display.

The surface with which the transformative tip (104) interfaces may be of a variety of types. For example, the surface may be a display screen on an electronic device, which display screen is responsive to touch inputs, such as from a finger or other device such as an electronic pen. In another example, the surface may be a paper surface that is specially-prepared to receive electronic inputs. For example, this specially-prepared paper may include features that are imperceptible to the human eye. As the tip passes over these features, it identifies the position of the tip on the specially-prepared paper surface.

To allow such digital interaction, an electrically conductive material (106) such as a conductive rubber, is formed over the transformative tip (104). This electrically conductive material (106) allows for an electrical input to be received, which as described above can be translated into an instruction to create a visual design element or execute an operation on the associated computing device.

As described above, the electronic input device housing (100) may be used for more than just as an electronic pen, but also as a physical writing implement. In this example, the transformative tip (104) changes form to selectively expose the writing implement as the writing implement advances through an opening in the transformative tip (104). In one example, the transformative tip (104) is a retractable cover disposed over the opening of the tip (104). When in a stylus mode, the retractable cover, which may be a flap or cone-shaped lid of electrically conductive material (106) over the opening, is closed thus allowing the transformative tip (104) to be used as an electronic pen. When used in a writing mode, the retractable cover is opened such that the writing implement may protrude and be used to generate physical marks on a surface.

In another example, the transformative tip (104) may be a deformable opening that enlarges as the writing implement advances. For example, the opening, when in the stylus mode, may be smaller than a diameter of the writing implement and small enough so as to not the electronic pen/digital surface interface. As the writing implement advances, it expands the diameter of the opening such that the writing implement may pass through and be used as intended. In other words, the electrically conductive material (106) that forms the transformative tip (104) in this example is flexible to change shape as the writing implement advances.

In some examples, the size of the opening before advancement of the writing implement may be smaller than the diameter of the writing implement, for example by half, so as to not impede use of the electronic input capability. For example, if the opening were sized to the diameter of the writing implement, accuracy of electronic pen input may be comprised due to the large contact surface. That is, a larger opening may result in less precise contact with the digital display, thus resulting in less precise conversion of pen movements to visual inputs and/or more difficulty interacting with buttons on the display screen, which may be small.

The electronic input device housing (100) includes a trigger (108). Upon activation, the trigger (108) 1) transforms the transformative tip (104), that is it changes its form, and 2) protracts and retracts the writing implement through the opening. In some cases, transforming the transformative tip (104) may be responsive to a force exerted by the movement of the writing implement. For example, the trigger (108) may be a spring-loaded mechanism to protract a pen towards the opening. Upon a subsequent depression, the trigger (108) may retract the pen into the shaft (102) body. As the writing implement tip contacts the retractable cover, it may overcome a force holding the retractable cover in place to expose the opening. In the example, the transformative tip (104) is a deformable opening, the writing implement tip may expand the opening as it passes through.

Accordingly, the present specification describes an electronic input device housing (100) that functions as a multi-device system, i.e., includes a physical writing implement and an electronic pen. The electronic input device housing (100) of the present specification also prevents contamination of mechanisms within the pen by including a transformative tip (104) that can be selectively closed and opened. The electronic input device housing (100), by covering the opening when to be used as an electronic pen, also increases the effectiveness and ease of use when in the stylus mode as an exposed opening of a large size, such as the diameter of the writing implement, may make electronic pen use less intuitive and may interrupt certain operations. Moreover, by covering the opening, damage to the digital display is prevented. For example, the sharp edges surrounding the opening may scratch or otherwise damage an electronic display. However, the transformative tip (104) which may be rounded and formed of a rubber material prevents such damage.

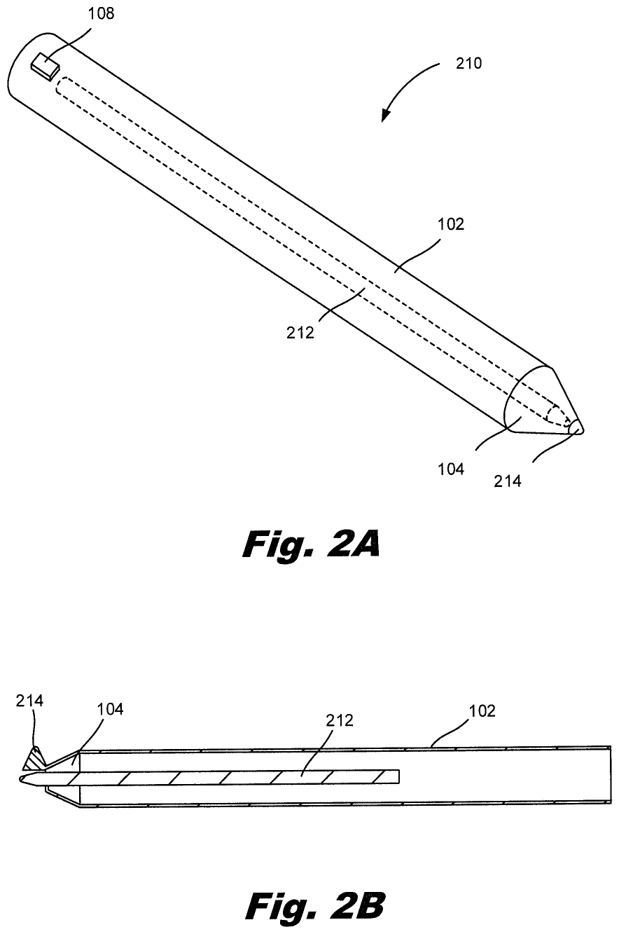

FIGS. 2A and 2B are views of an electronic input device (210) with a retractable cover (214), according to an example of the principles described herein. Specifically, FIG. 2A is an isometric view of the electronic input device (210) and FIG. 2B is a cross-sectional view of the electronic input device (210).

The electronic input device (210) includes an electronic input device housing (FIG. 1, 100). The electronic input device housing (FIG. 1, 100) holds other components of the electronic input device (210) including the writing implement (212) and mechanisms for moving the writing implement (212) in and out of the opening in the transformative tip (104). The electronic input device housing (FIG. 1, 100) may house other components such as processors and other circuitry and hardware to facilitate use with a digital display.

The electronic input device housing (FIG. 1, 100) includes a shaft (102) with a transformative tip (104). As the transformative tip (104) moves across a digital surface or touch-sensitive surface, a visual representation is made on a display (e.g., the surface) that corresponds to the movement of the transformative tip (104). In some examples, contact of the transformative tip (104) with the surface causes a function to execute on an electronic device to which the surface is coupled. For example, a user may tap on a certain portion of the surface with the transformative tip (104) to position a cursor on that portion of the surface. In another example, a user may tap on an icon on the surface, and an operation may be executed on the electronic device. In some examples, the transformative tip (104) may be formed of metal. In this example, the transformative tip (104) may be covered by the electrically conductive material (FIG. 1, 106). In other examples, the transformative tip (104) may be formed of another material, such as rubber.

The shaft (102), in addition to providing the transformative tip (104) that a user can communicate with an electronic display, provides a surface which a user can grasp to manipulate the electronic input device (210). In some examples, the shaft (102) has a rubber sleeve, or other ergonomic feature, disposed along at least a portion of its length to provide a grip. The grip provides a greater friction force such that a user can grasp the shaft (102) and more easily manipulate the electronic input device (210) to interact with the surface. The shaft (102) may be formed of any material such as plastic or metal.

As described above, the electronic input device housing (FIG. 1, 100) includes a transformative tip (104) which may take many forms. In the example depicted in FIGS. 2A and 2B, the transformative tip (104) comprises a retractable cover (214) disposed over an opening in the transformative tip (104) through which the writing implement (212) is advanced. As depicted in FIG. 2B, the retractable cover (214) may be opened when the writing implement (212), via user action, is advanced through the opening. In some examples, the retractable cover (214) may have a rounded plastic shape so as to not damage the surface with which it interacts.

The electronic input device (210) also includes a writing implement (212) disposed within the shaft (102). The writing implement (212) may take many forms. For example, the writing implement (212) may be an ink pen. In another example, the writing implement (212) may be a pencil.

FIG. 2A also depicts at least one trigger (108) that advances the writing implement (212) through the opening. As with the writing implement (212), the trigger (108) may take many forms. For example, in the case the writing implement (212) is a pencil, the trigger (108) may mechanically advance the pencil lead. In this example, multiple activations of the trigger (108) advance the pencil lead further outside of the opening. In this example, the pencil may be retracted by depressing the trigger (108) and pushing the pencil lead back in.

In other examples, the pencil lead is exposed via one activation of the trigger (108) and retracted via another activation of the same trigger (108) or of another trigger (108). In some examples, the trigger (108) may be a spring-loaded actuator that moves the writing implement (212) out the opening. While FIGS. 2A and 2B depict the trigger (108) in a particular location, the trigger (108) may be located at other locations, such as on the end of the shaft (102).

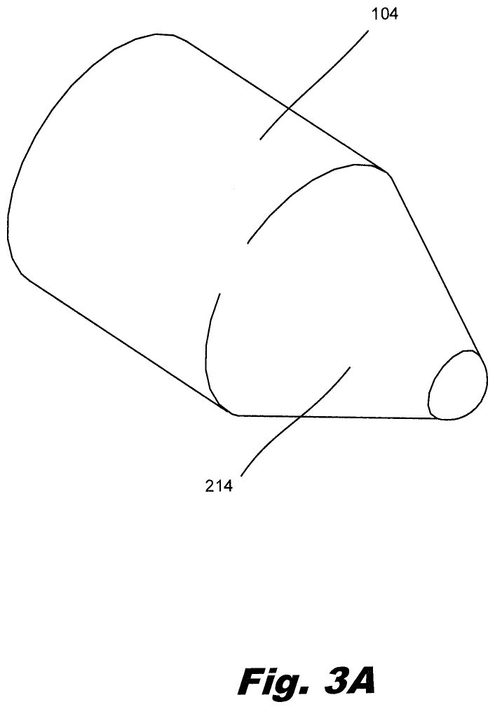

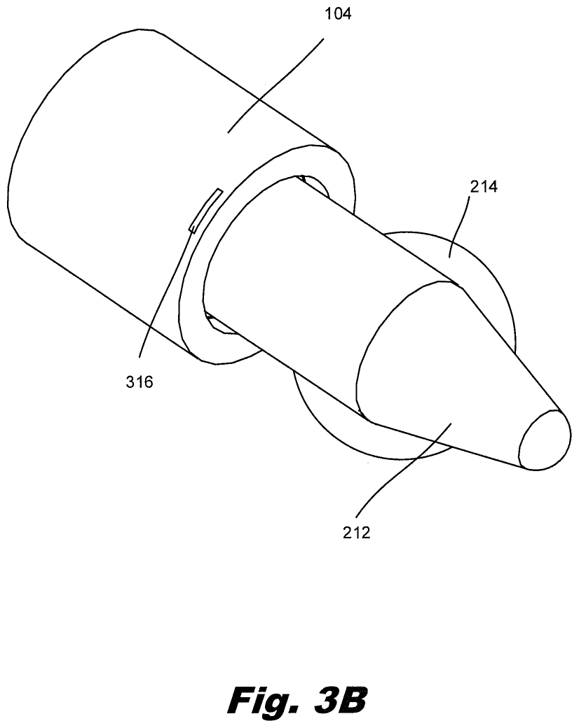

FIGS. 3A and 3B are zoomed-in views of the transformative tip (104) of the shaft (FIG. 1, 102) of the electronic input device (FIG. 2, 210) and the retractable cover (214), according to an example of the principles described herein. As described above, the retractable cover (214) may hingedly open and close. In some examples, the hinge between the shaft (102) and the retractable cover (106) may be a living hinge, meaning that it is formed of the same material as the two components which it joins. For example, the transformative tip (104) of the shaft (FIG. 1, 102) may be covered with, or formed by, an electrically conductive material (106) and the retractable cover (214) may similarly be formed of this material. In other examples, the hinge may be formed of another material, such as metal. In this example, the hinge may be uncovered or may be covered with the electrically conductive material (FIG. 1, 106).

While FIG. 3A depicts the retractable cover (214) as cone-shaped, or nib-shaped, in some examples the retractable cover (214) may be a flap of the electrically conductive material (FIG. 1, 106) that hingedly covers the opening.

As described above, in some examples, the retractable cover (214) biases towards the closed position. That is, without some force, such as a writing implement (212) pushing against it, the retractable cover (214) may move towards covering the opening. In other words, mechanical equilibrium for the retractable cover (214) may be when it covers the opening. In another example, once opened, the retractable cover (214) may be re-closed via manual action. That is, the user may close the retractable cover (214) with their finger.

As depicted in FIG. 3B, the retractable cover (214) may be forced open by action of the trigger (FIG. 1, 108) to move the writing implement (212) out of the orifice. That is, as the writing implement (212) is directed out of the opening via action of the trigger (FIG. 1, 108), it pushes against the retractable cover (214) to move it out of the way such that the tip of the writing implement (212) is exposed.

As described above, the retractable cover (214) may or may not be biased towards the closed position. In either case, the electronic input device housing (FIG. 1, 100) may include a lock to retain the retractable cover (214) in a closed position when the writing implement (212) is retracted inside the shaft (102). For example, the shaft (102) of the electronic input device housing (FIG. 1, 100) may include a detent (316) that interfaces with a tab on the retractable cover (214) to hold the retractable cover (214) in a closed position. While FIG. 3B depicts a specific example where the lock is a detent (316), other forms of locks may be used as well. For example, the cross-section ring of the opening may include a magnetic material that interfaces with corresponding magnets on the retractable cover (214) to retain it in a closed position. Such a lock prevents undesired opening of the retractable cover (214), for example when being used as a stylus or electronic pen.

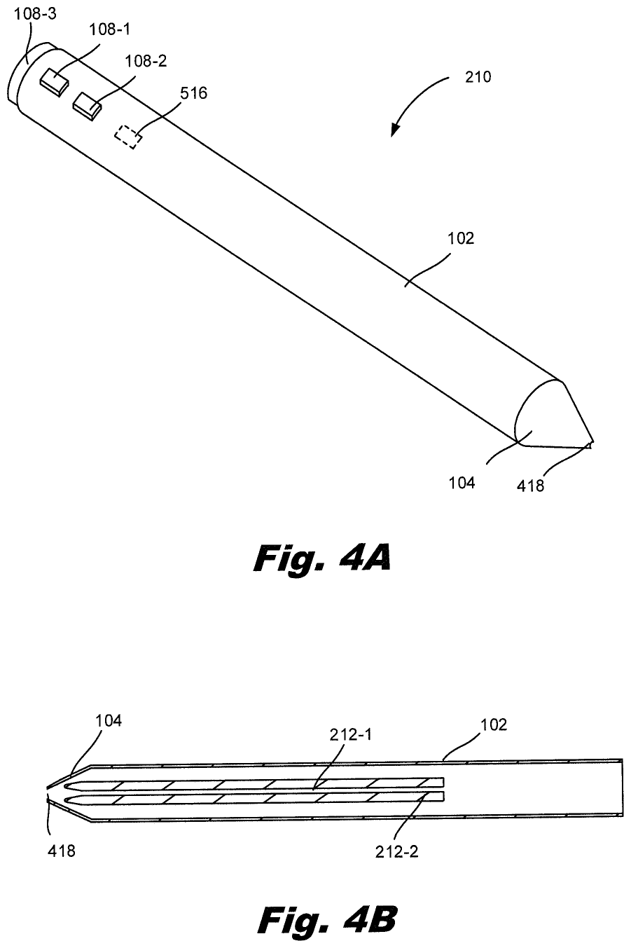

FIGS. 4A and 4B are views of an electronic input device (210) with a deformable opening (418), according to another example of the principles described herein. Specifically, FIG. 4A is an isometric view of the electronic input device (210) and FIG. 4B is a cross-sectional view of the electronic input device (210). FIGS. 4A and 4B depict various components similar to those previously described including the electrically conductive material (FIG. 1, 106) that covers a transformative tip (104) of the shaft (104). FIG. 4A depicts other components that may also be placed on the electronic input device housing (FIG. 1, 100). Specifically, the electronic input device housing (FIG. 1, 100) may include multiple triggers (108), that each may carry out different functions. For example, a first trigger (108-1) may advance the writing implement (FIG. 2, 212). In this example, a second trigger (108-2) may retract the writing implement (FIG. 2, 212). In the example depicted in FIGS. 4A and 4B, the electronic input device (210) includes multiple writing implements (212-1, 212-2) retained within the cylindrical shaft (102). In this example, there may be multiple triggers (108), each to advance a different writing implement (FIG. 2, 212). FIG. 4A also depicts different types of triggers (108). For example, first and second triggers (108-1, 108-2) are buttons on a side of the shaft (102) whereas a third trigger (108-3) is a button on the end of the shaft (102). While FIG. 4A depicts various types and orientations of a certain quantity of triggers (108), the electronic input device housing (FIG. 1, 100) may include any quantity of any type of trigger (108), which triggers (108) carry out particular functions.

In some examples, the electronic input device (210) also includes an electronic tracking device (516) to locate the electronic input device (210). That is, over time, a user may lose/forget where they have placed the electronic input device (210). The electronic tracking device (516) aids in locating the electronic input device (210) in such a circumstance. The electronic tracking device (516) uses other computing devices to find the location of the electronic input device (210) whether or not there is power to the electronic input device (210).

In one particular example, an application in a computing device acquires the location information from the electronic tracking device (516). The location data can be transmitted to a gateway. The gateway can be accessed by internet and may provide the location information of the electronic input device (210) to external mobile devices, for example, a laptop or mobile phone of the user. In one particular example, using a triangulation operation, a location system can identify the location of the electronic input device (210) whether the electronic input device (210) is powered on or off.

In this example, the electronic tracking device (516) may include a tag with identification information as well as a small battery that may be active for a long period of time, for example, ten years. Using the transmission speed of information to and from the electronic tracking device (516) to different computing devices, an exact location of the electronic input device (210) may be determined.

In some examples, the transmission range of the electronic tracking device (516) may be around 15 kilometers. As a particular example, three fixed location computing devices serve as the base gateway index of the network. The location of electronic input device (210) may be determined using three pieces of information: the time stamp of the transmit signal, Tₜₓ, the time stamp of the receive signal, Tᵣₓ, and the transmit speed of the message packet which may be fixed in the network. For each fixed location, a radial distance of the electronic input device (210) away from the fixed location may be determined using the following expression.

(Tₜₓ−Tᵣₓ)/S=Rₓ (Expression 1)

Accordingly, knowing the fixed location of each computing device and a radial distance of the electronic input device (210) from the respective computing device, the location of the electronic input device (FIG. 2, 210) can be calculated using triangulation. That is, the intersection of the three radial distances is the location of the electronic input device (FIG. 2, 210).

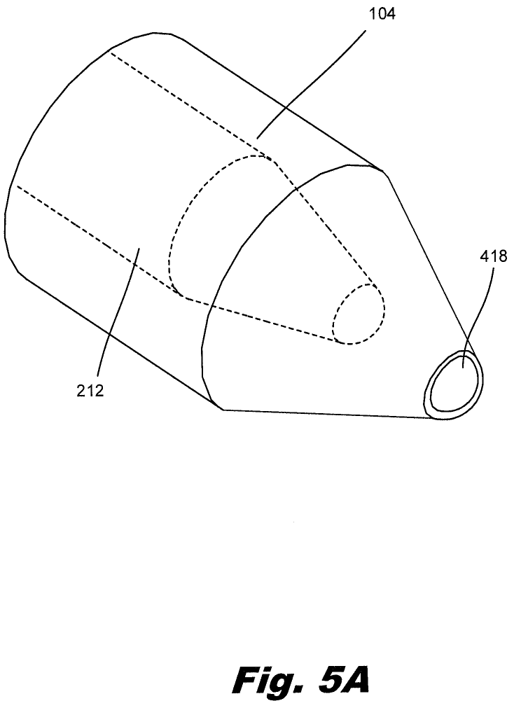

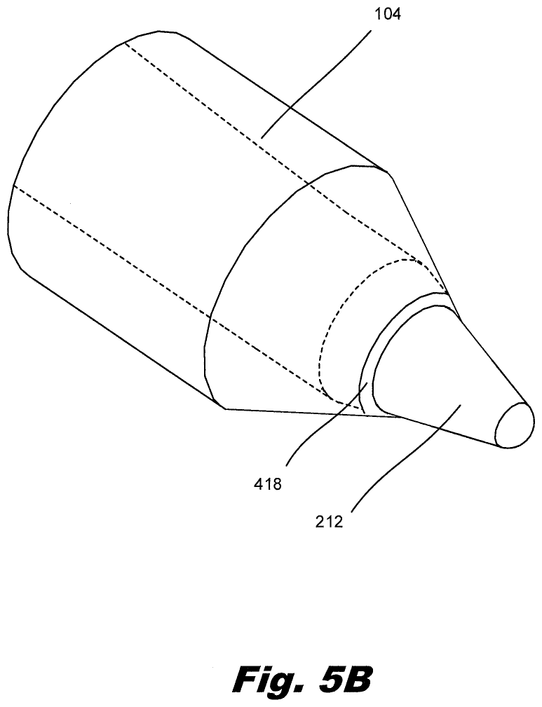

FIG. 5B is a cross-sectional view of an electronic input device (212) with a deformable opening (418), according to another example of the principles described herein. In this example, the deformable opening (418) is in a closed state, i.e., it has an opening diameter that is smaller than when open. In the closed state, the opening may be smaller than a diameter of a single writing implement (212) or either writing implement (212). In some cases, the diameter of the opening may be less than half of the diameter of the writing implement (212). In the case of a pencil lead, the diameter of the opening (418) may be the same size, but is still sufficiently small to not interfere with use of the electronic input device (210) with an electrically conductive tip on a digital surface.

As depicted in FIG. 4B, the shaft (102) houses multiple writing implements (212-1, 212-2). In some examples, the different writing implements (212) may be of different types. For example, a first writing implement (212-1) may be a pen and a second writing implement (212-2) may be a pencil. As described above, each writing implement (212) may be triggered via actuation of different triggers (108) or in some examples via a single trigger (108). For example, the trigger (108) may be able to rotate and when rotated to one position, depressing the trigger (108) may retract or advance a first writing implement (212-1). Rotating the trigger (108) to a second position, and depressing the trigger (108) in this position may retract or advance a second writing implement (212-2). Accordingly, the electronic input device (210) of this example includes multiple physical writing implements (212) as well as a deformable opening (418) which may be used as an electronic pen with a digital display.

FIGS. 5A and 5B are zoomed-in views of the tip of the shaft of the electronic input device and the deformable opening, according to an example of the principles described herein. FIG. 5A clearly depicts the writing implement (212) internal to the shaft (102) before deployment. As can be seen the deformable opening (418) is smaller than the diameter of the shaft of the writing implement (212). Note that the components, i.e., opening (418), transformative tip (104), and writing implement (212) are not drawn to scale, but may be enlarged for illustrative purposes. For example, the opening may be a cut or slit in a deformable material that naturally generates some pressure to have each side of the slit touching but is overcome by pressure when the pen is protracted to open and/or widen the opening. In some examples, a seal or covering may be disposed over the deformable opening (418) during use of the electronic input device (FIG. 1, 100) as an electronic pen.

As the writing implement (212) is advanced via action of the trigger (FIG. 1, 108), the opening (418) enlarges as depicted in FIG. 5B such that the writing implement may be used. Accordingly, in this example, the transformative tip (104) may be formed of a flexible, or elastically deformable material such that it can enlarge to allow the writing implement (212) may pass, but that returns to its original form, i.e., with a smaller opening (418) after the writing implement is retracted.

Such devices and systems 1) facilitate electronic pen use and physical writing implement use in a single device; automatically extract a desired writing implement; and 3) covers any orifice when a writing implement is not in use to prevent contamination. However, it is contemplated that the devices disclosed herein may address other matters and deficiencies in a number of technical areas.

What is claimed is:

1. An electronic input device housing, comprising:
a shaft to house a writing implement;
a transformative tip coupled to the shaft to selectively expose the writing implement as the writing implement advances through an opening in the transformative tip;
an electrically conductive material formed over the transformative tip; and
a trigger to advance the writing implement through the opening.

2. The electronic input device housing of claim 1, wherein the transformative tip comprises a retractable cover disposed over the opening to open as the writing implement is advanced through the opening.

3. The electronic input device housing of claim 2, further comprising a flap of electrically conductive material to hingedly attach the retractable cover to the shaft.

4. The electronic input device housing of claim 2, further comprising a lock to retain the retractable cover in a closed position when the writing implement is retracted inside the shaft.

5. The electronic input device housing of claim 1, wherein the transformative tip comprises a deformable opening to expand as the writing implement is advanced through the opening.

6. The electronic input device housing of claim 1, wherein the shaft is to house a writing implement selected from the group consisting of a pen and a pencil.

7. The electronic input device housing of claim 1, wherein:
the trigger is to mechanically advance a pencil lead; and
multiple activations of the trigger advance the pencil lead further out the opening.

8. The electronic input device housing of claim 1, wherein the trigger is a spring-loaded actuator.

9. The electronic input device housing of claim 1, further comprising a second trigger to retract the writing implement.

10. An electronic input device, comprising:
a housing comprising:
a shaft;
a transformative tip coupled to the shaft, the transformative tip comprising an opening through which a writing implement is to advance during use;
an electrically conductive material formed over the transformative tip; and
a trigger to advance the writing implement through the opening; and
a writing implement disposed within the shaft.

11. The electronic input device of claim 8, wherein:
the writing implement comprises multiple writing implements;
a first writing implement is a pen; and
a second writing implement is a pencil.

12. The electronic input device of claim 8, further comprising an electronic tracking device to locate the electronic input device.

13. An electronic input device, comprising:
a housing comprising:
a cylindrical shaft;
a transformative tip coupled to the shaft, the transformative tip comprising an opening through which a writing implement is to advance during use;
an electrically conductive material formed over the transformative tip, the electrically conductive material to interface with a surface; and
a trigger to advance the writing implement through the opening; and
multiple writing implements retained in the cylindrical shaft.

14. The electronic input system of claim 13, wherein the a trigger comprises multiple triggers, each trigger to advance a different writing implement through the opening.

15. The electronic input system of claim 13, wherein different of the multiple writing implements are of different types.
